(19) United States
(12) Patent Application Publication
(10) Pub. No.: US 2003/0188968 A1
(43) Pub. Date: Oct. 9, 2003

(54) Gas sensing element

(75) Inventors: Susumu Naito, Kariya-shi (JP); Shinichiro Imamura, Chiryu-shi (JP); Makoto Nakae, Nagoya (JP); Namitsugu Fujii, Yokkaichi-shi (JP)

Correspondence Address: NIXON & VANDERHYE, PC, 1100 N GLEBE ROAD, 8TH FLOOR, ARLINGTON, VA, 22201-4714, US

(73) Assignee: DENSO CORPORATION

(21) Appl. No.: 10/396,753

(22) Filed: Mar. 26, 2003

(30) Foreign Application Priority Data
Jan. 31, 2003 (JP) 2003-023420
Apr. 3, 2002 (JP) 2002-101540

(51) Int. Cl. G01N 27/26

(52) U.S. Cl. 204/424; 204/426; 204/431

(57) ABSTRACT

A measuring objective gas side electrode is provided on a surface of a solid electrolytic substrate. A reference electrode is provided on another surface of the solid electrolytic substrate. The measuring objective gas side electrode is exposed to a chamber. A gas introducing passage extends to connect the chamber to an external environment of the gas sensing element. A relationship S/Ld≦1.5 is established, where S represents a cross-sectional area of an inner open end of the gas introducing passage opening to the chamber, L represents a circumferential length of the inner open end, and d represents a thickness of the chamber in the vicinity of the inner open end of the gas introducing passage.

### BACKGROUND OF THE INVENTION

1. Field of the Invention

The present invention relates to a gas sensing element which is usable for combustion control of an internal combustion engine of an automotive vehicle.

2. Description of the Background Art

A gas sensor, incorporating an A/F sensing element, is provided in an exhaust gas system of an automotive engine. An air-fuel ratio of the gas mixture introduced into a combustion chamber is detected or estimated based on an oxygen concentration in the exhaust gas. The combustion control of the engine is performed based on the air-fuel ratio being thus detected.

When a ternary catalyst is employed for purifying the exhaust gas emitted from the automotive engine, it is important that the air-fuel ratio of the gas mixture introduced into the combustion chamber of the automotive engine is accurately maintained to a specific or optimum value to assure efficient exhaust gas purification.

In other words, using an A/F sensing element for accurately measuring the air-fuel ratio makes it possible to realize high accurate combustion control. The exhaust gas purification efficiency based on the ternary catalyst can be increased. This is the principle of an ordinary exhaust gas feedback control system.

Japanese Patent Application Laid-open No. 2000-275215, Japanese Patent Application Laid-open No. 2000-65782, and Japanese Patent No. 2748809 disclose conventional gas sensing elements.

Nowadays, increasing the exhaust gas purification efficiency is highly required. The measuring accuracy of an air-fuel ratio sensing element used in such an exhaust gas feedback control system must be excellent. Accurately detecting a momentarily varying condition of the exhaust gas is essentially important to realize a reliable air-fuel ratio control and, as a result, to improve or enhance the exhaust gas purification efficiency. A sensing element possessing high-accurate measuring capability is definitely necessary for the A/F sensor. Using such a high-accurate sensing element is a key for providing an exhaust gas feedback control system having improved performance.

Besides the A/F sensing element, the gas sensing elements used in this kind of exhaust gas feedback control system are, for example, a sensing element capable of detecting the concentration of oxygen in the exhaust gas and another type of sensing element capable of directly detecting the concentration of NOx (i.e., notorious air pollution substance) contained in the exhaust gas. These various types of gas sensing elements are similarly subjected to the above-described severe requirements.

### SUMMARY OF THE INVENTION

In view of the foregoing problems in the prior art, the present invention has an object to provide a gas sensing element having excellent measuring accuracy.

In other to accomplish the above and other related objects, the present invention provides a first gas sensing element including a solid electrolytic substrate, a measuring objective gas side electrode provided on a surface of the solid electrolytic substrate, and a reference electrode provided on another surface of the solid electrolytic substrate. According to the first gas sensing element, the measuring objective gas side electrode is exposed to a chamber. A gas introducing passage is provided for connecting the chamber to an external environment of the gas sensing element. A relationship S/Ld≦1.5 is established, where S represents a cross-sectional area of an inner open end of the gas introducing passage opening to the chamber, L represents a circumferential length of the inner open end of the gas introducing passage, and d represents the thickness of the chamber in the vicinity of the inner open end of the gas introducing passage.

Furthermore, the present invention provides a second gas sensing element including a solid electrolytic substrate, a measuring objective gas side electrode provided on a surface of the solid electrolytic substrate, and a reference electrode provided on another surface of the solid electrolytic substrate. According to the second gas sensing element, the measuring objective gas side electrode is exposed to a chamber. A gas introducing passage is provided for connecting the chamber to an external environment of the gas sensing element. A diffusion resistive layer, which is made of a porous member, covers an outer opening portion of the gas introducing passage at an external environment side of the gas introducing passage. No additional diffusion resistive member is provided on an outer surface of the diffusion resistive layer. A relationship S/Ld≦1.5 is established, where S represents a cross-sectional area of an inner open end of the gas introducing passage opening to the chamber, L represents a circumferential length of the inner open end of the gas introducing passage, and d represents the thickness of the chamber in the vicinity of the inner open end of the gas introducing passage.

Each of the first gas sensing element and the second gas sensing element includes the measuring objective gas side electrode which is exposed to the chamber. The gas introducing passage provides a diffusion path for connecting the chamber to the external environment of the gas sensing element. The second gas sensing element further includes the diffusion resistive layer covering the outer opening portion of the introducing passage. The relationship S/Ld≦1.5 is established, where S represents the cross-sectional area of the inner open end of the gas introducing passage opening to the chamber, L represents the circumferential length of the inner open end of the gas introducing passage, and d represents the thickness of the chamber in the vicinity of the inner open end of the gas introducing passage.

The first gas sensing element measures the concentration of the measuring objective gas entering into the chamber via the gas introducing passage. The second gas sensing element measures the concentration of the measuring objective gas entering into the chamber via the diffusion resistive layer and the gas introducing passage.

The output of a gas sensing element is dependent upon the external environment and the gas diffusion resistive structure provided in the sensor. Satisfying the relationship S/Ld≦1.5 is effective to eliminate the influence of the inner open end of the gas introducing passage opening to the chamber in determining the diffusion rate of the measuring objective gas.

Accordingly, the first gas sensing element and the second gas sensing element can produce a sensor output reflecting the condition of the external environment.

According to the arrangement of the first gas sensing element of the present invention, it is easy to adjust the distance of the gas introducing hole ranging from its external opening portion to the inner open end. For example, the length of the gas introducing passage is adjustable by cutting the surface of a plate member across which the gas introducing passage is formed after the gas sensing element is finished. Alternatively, according to the second gas sensing element, the length of the gas introducing passage can be reduced by cutting the surface of the diffusion resistive layer. Accordingly, satisfying the above relationship S/Ld≦1.5 makes it sure to provide a gas sensing element which is easy to adjust the sensor output after the gas sensing element is accomplished and assures high accuracy in the output adjustment.

In general, the measuring objective gas amount entering into the chamber, i.e., the flowing speed of the measuring objective gas, gives large influence to the sensor output. However, according to the first and second gas sensing elements, adjusting of the sensor output can be easily done after the sensing element is manufactured. In other words, the present invention provides a gas sensing element which is capable of easily suppressing the manufacturing dispersion of the sensor output based on the above sensor output adjustment and is also capable of assuring accurate measuring accuracy.

The relationship among S, L and d established for the first and second gas sensing elements will be explained hereinafter.

The gas introducing passage opens to the chamber. It is now assumed that the cross-sectional area of the inner open end of the gas introducing passage is S, the circumferential length of the inner open end of the gas introducing passage is L, and the thickness of the chamber in the vicinity of the inner open end of the gas introducing passage is d in average.

In general, it is difficult to accurately control or administrate the diameter of the gas introducing passage of a gas sensing element. In the manufacturing processes of a gas sensing element, a predetermined number of ceramic sheets are laminated and then sintered.

During the manufacturing processes of a gas sensing element, the gas introducing passage is formed as a pinhole in a ceramic green sheet before this sheet is sintered. The ceramic green sheet shrinks when it is sintered later. Hence, the pinhole size varies undesirably through the sintering operation.

The manufacturing processes further include lamination and bonding of another green sheet to the ceramic green sheet across which the gas introducing passage is formed. Thus, finely controlling or administrating the diameter of the gas introducing passage is difficult.

The limit current value of a gas sensing element is determined depending upon the thickness d of the chamber. However, the thickness of the chamber tends to vary during the manufacturing processes of the gas sensing element. In general, the chamber is defined as a window opened within a ceramic green sheet. This green sheet shrinks when it is sintered. Furthermore, this green sheet is laminated and bonded to other green sheet. Thus, finely controlling or administrating the thickness of the chamber is difficult.

When S/Ld is larger than 1.5, there is the possibility that the diffusion rate is substantially determined by the inner open end of the gas introducing passage located at the boundary between the gas introducing passage and the chamber. Hence, it becomes difficult to perform the above-described sensor output adjustment.

In the case that a sensing element has a plurality of gas introducing holes, the condition of S/Ld is established for each gas introducing passage.

Furthermore, according to the above-described first and second sensing elements of the present invention, the diffusion path of the measuring objective gas introduced into the chamber is substantially constituted by a single path. According to the first gas sensing element, the diffusion path of the measuring objective gas is constituted by the introducing passage only. According to the second gas sensing element, the diffusion path of the measuring objective gas is constituted by the introducing passage and the diffusion resistive layer. No superposition of sensor signals will appear in a transient response phase. The high accurate measurement of a gas sensing element can be assured.

Furthermore, according to the above-described first and second sensing elements of the present invention, both the measuring objective electrode and the reference electrode are provided on the surfaces of the oxygen ion conductive solid electrolytic substrate. These electrodes and the solid electrolytic substrate cooperatively constitute an electrochemical cell. The concentration of a specific gas contained in the measuring objective gas is measurable based on an oxygen ion current flowing across the electrochemical cell.

Namely, the above-described chamber of the gas sensing element is an inside space formed in the gas sensing element. The measuring objective gas flows into this chamber via the gas introducing passage according to the first gas sensing element, or via the gas introducing passage and the diffusion resistive layer according to the second gas sensing element. The introducing passage (and the diffusion resistive layer) substantially determines the diffusion rate of the measuring objective gas introduced into the chamber. The electrochemical cell possesses the limit current characteristics corresponding to the concentration of the specific gas contained in the measuring objective gas. Therefore, it is possible to measure the concentration of the specific gas.

More specifically, the first and second gas sensing element of the present invention can measure the specific gas concentration based on the oxygen ion current flowing in accordance with the gas concentration difference between the measuring objective gas and the reference gas.

Furthermore, the measuring objective gas side electrode decomposes the specific gas. Accordingly, the measurement of the specific gas concentration can be performed based on the oxygen ion current caused by the oxygen ions decomposed from the specific gas.

Furthermore, an electric potential difference reflecting the specific gas concentration appears between the measuring objective gas side electrode and the reference electrode. Thus, the measurement of the specific gas concentration can be performed based on the potential difference between the measuring objective gas side electrode and the reference electrode.

For example, the first or second gas sensing element of the present invention is an oxygen sensing element which measures the concentration of oxygen contained in the measuring objective gas. Besides the oxygen sensing element, the first or second gas sensing element can be used as another type of gas sensing element which is capable of measuring the concentration of a specific gas, such as NOx, CO and HC, according to which the concentration of oxygen decomposed from the specific gas is measured and the concentration of the specific gas is detected.

Furthermore, the first or second gas sensing element of the present invention can be installed in the exhaust gas system of an internal combustion engine. The oxygen concentration in the exhaust gas of the internal combustion engine is measured by this element. The sensing value of the gas sensing element is used to detect or estimate the air-fuel ratio of a gas mixture introduced into a combustion chamber of the internal combustion engine.

The above-described gas introducing passage of the first or second gas sensing element can be constituted by a pinhole extending across a substrate defining a wall of the chamber.

Furthermore, according to the second gas sensing element of the present invention, providing the diffusion resistive layer makes it possible to prevent the sensor output from varying depending upon the temperature of the measuring objective gas. The sensor output can be accurately obtained.

Furthermore, after the diffusion resistive layer is formed, it is possible to perform a fine adjustment of the sensor output by cutting or trimming the diffusion resistive layer. This arrangement is advantageous in that there is no necessity of additionally providing an external adjusting circuit.

Moreover, according to the second gas sensing element of the present invention, no additional diffusion resistive member is provided on the outer surface of the diffusion resistive layer. With this arrangement, the diffusion path of the measuring objective gas introduced into the chamber is substantially constituted by a single path. No superposition of sensor signals will appear in a transient response phase. The high accurate measurement can be assured.

However, a trap layer or another comparable layer has a negligible diffusion resistance compared with the diffusion resistive layer. Hence, it is possible to provide this kind of additional layer on the diffusion resistive layer.

It is preferable that S, L and d satisfy a relationship 0.25≦S/Ld≦1.25.

With this arrangement, manufacturing dispersion of the sensor output can be suppressed. It becomes possible to provide a gas sensing element having excellent measuring accuracy.

When S/Ld is less than 0.25, the limit current is suppressed to small values. The output control becomes unfeasible. On the other hand, when S/Ld is larger than 1.25, there is the tendency that the manufacturing dispersion of the sensor output becomes large.

It is also preferable that at least one another introducing passage is provided in addition to the above-described gas introducing passage.

The path for introducing the measuring objective gas into the chamber is constituted by the gas introducing passage and also, according to the second gas sensing element, by the diffusion resistive layer. When the area of the outer opening portion of the gas introducing passage opening to the external environment is constant, the diffusion resistance is not dependent on the number of gas introducing passages. Providing a plurality of gas introducing passages brings the effect of separating the path of the measuring objective gas so that the measuring objective gas can be promptly introduced into the chamber. The response of the gas sensing element is improved.

It is also preferable that the gas sensing element is a two-cell type.

The arrangement of the gas sensing element can be preferably applied to the two-cell type gas sensing element so as to suppress the manufacturing dispersion of the sensor output.

For example, the practical two-cell type gas sensing element includes pump cell electrodes for adjusting the oxygen concentration in the chamber or may include monitor sensor electrodes for monitoring the oxygen concentration in the chamber.

For example, the first or second gas sensing element of the present invention is a two-cell type element having a sensor cell for measuring the concentration of a specific gas contained in the measuring objective gas introduced in the chamber and an oxygen pump cell for charging or discharging oxygen into or from the chamber. The sensor cell includes a solid electrolytic substrate, a measuring objective gas side electrode provided on the solid electrolytic substrate, and a reference electrode exposed to a reference gas chamber into which the air is introduced. The sensor cell is positioned so as to face the inner open end of the gas introducing passage where the gas introducing passage opens into the chamber. The pump cell includes a solid electrolytic substrate and a pair of pump electrodes provided on the solid electrolytic substrate. And, one of the pump electrodes is positioned so as to be exposed to the chamber.

With this arrangement, it becomes possible to obtain a gas sensing element with a sensor cell and an oxygen pump cell which is capable of suppressing manufacturing dispersion of the sensor output.

Furthermore, the sensor cell used in this arrangement has the capability of decomposing the specific gas contained in the measuring objective gas and measuring the specific gas concentration based on the decomposed oxygen. Accordingly, it becomes possible to accurately detect the specific gas concentration by the arrangement that the specific gas detects only the oxygen ions derived from the specific gas while the oxygen pump cell charges and discharges the oxygen to adjust the oxygen concentration in the chamber.

Preferably, the gas introducing passage has an outer opening portion opening to the external environment, and a trap layer for trapping poisonous components contained in the measuring objective gas is provided so as to cover the outer opening portion of the gas introducing passage.

For example, the trap layer for trapping poisonous components contained in the measuring objective gas is provided on the outer surface of the diffusion resistive layer.

With this arrangement, the poisonous components can be trapped by the trap layer. The gas concentration detection can be stably performed for a long time.

The above-described trap layer has a very small diffusion resistance compared with the diffusion resistive layer. In other word, the diffusion resistance of the trap layer is a negligible factor in determining the diffusion rate of the measuring objective gas.

For example, the above-described trap layer is formed by sintered heat-resistive particles. In practice, a ceramic layer with pores having the porosity in the range from 50% to 90% has no substantial diffusion resistance.

### BRIEF DESCRIPTION OF THE DRAWINGS

These and other objects, features, aspects and advantages of the present invention will become more apparent from the following detailed description of the present invention when taken in conjunction with the accompanying drawings.

FIG. 1 is a cross-sectional view showing a gas sensing element in accordance with a first embodiment of the present invention;

FIG. 2A is a perspective view showing a relationship between a chamber and an inner open end of a gas introducing passage, with definition of a cross-sectional area S and a circumferential length L of the inner open end of the gas introducing passage as well as a thickness d of the chamber in the vicinity of the inner open end of the gas introducing passage;

FIG. 2B is a plan view of FIG. 2A;

FIG. 3 is a graph showing a relationship between a limit current value and S/Ld in accordance with the first embodiment of the present invention;

FIG. 4 is a cross-sectional view showing a gas sensing element in accordance with a second embodiment of the present invention, which has no diffusion resistive layer;

FIG. 5 is a cross-sectional view showing a gas sensing element in accordance with a third embodiment of the present invention, which is a two-cell type gas sensing element;

FIG. 6 is a cross-sectional view showing a gas sensing element in accordance with a fourth embodiment of the present invention, which has a total of five gas introducing passages;

FIG. 7 is a cross-sectional view showing a gas sensing element in accordance with a fifth embodiment of the present invention, which has a trap layer;

FIG. 8 is a cross-sectional view showing a gas sensing element in accordance with a sixth embodiment of the present invention, which is a two-cell type gas sensing element equipped with a trap layer;

FIG. 9 is a cross-sectional view showing a gas sensing element in accordance with a seventh embodiment of the present invention, which has a diffusion resistive layer and a trap layer covering a total of five gas introducing passages; and

FIG. 10 is a cross-sectional view showing a comparative gas sensing element.

### DESCRIPTION OF THE PREFERRED EMBODIMENTS

Hereinafter, preferred embodiments of the present invention will be explained with reference to the attached drawings.

### First Embodiment

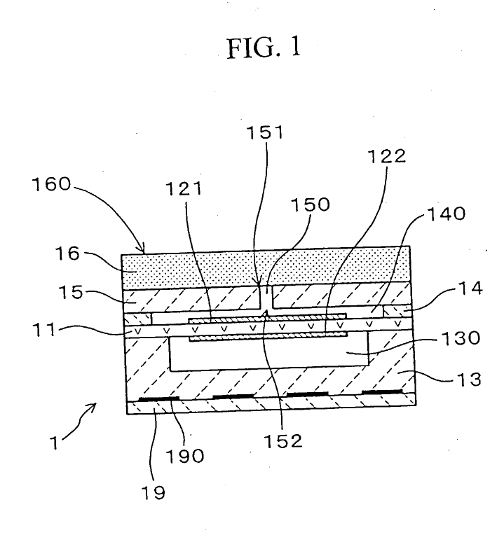

As shown in FIG. 1, a gas sensing element 1 of the first embodiment of the present invention includes a solid electrolytic substrate 11, a measuring objective gas side electrode 121 provided on a surface of the solid electrolytic substrate 11, and a reference electrode 122 provided on another surface of the solid electrolytic substrate 11. The measuring objective gas side electrode 121 is exposed to a chamber 140. A gas introducing passage 150 is provided to connect the chamber 140 to an external environment of the gas sensing element 1. A diffusion resistive layer 16, which is made of a porous member, covers an outer opening portion 151 of the gas introducing passage 150 at an external environment side of the gas introducing passage 150.

The diffusion resistive layer 16 is directly exposed to the external environment, with no additional diffusion resistive member provided on an outer surface 160 of this diffusion resistive layer 16.

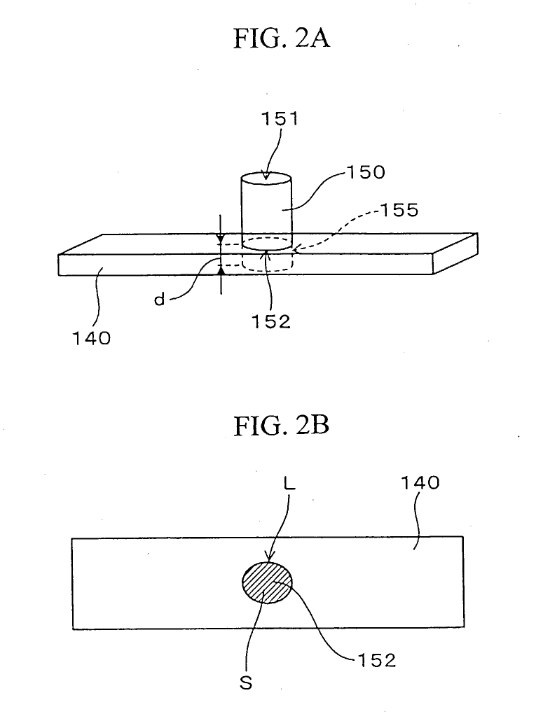

As apparent from the illustration of FIGS. 1, 2A and 2B, “S” represents a cross-sectional area of an inner open end 152 of the gas introducing passage 150 opening to the chamber 140, “L” represents a circumferential length of the inner open end 152 of the gas introducing passage 150, and “d” represents the thickness of the chamber 140 in the vicinity of the inner open end 152 of the gas introducing passage 150 taken along a line normal to the inner open end 152 of the gas introducing passage 150. The thickness “d” is the height of a virtual circular cylinder 155 which is an elongated part of the gas introducing passage 150 protruding into the chamber 140.

Among the above-defined dimensions S, L and d, a relationship S/Ld≦1.5 is established.

FIG. 2A is a perspective view illustrating the chamber 140 and the gas introducing passage 150, while FIG. 2B is a plan view showing a positional relationship between the chamber 140 and the inner open end 152 of the gas introducing passage 150.

The gas sensing element 1 of the first embodiment is housed or assembled in a gas sensor and is installed in an exhaust gas system of an automotive engine. The gas sensor is an essential component constituting an exhaust gas feedback control system. The gas sensing element 1 measures the concentration of oxygen contained in the exhaust gas to detect or estimate an air-fuel ratio of the gas mixture introduced in a combustion chamber of the automotive engine.

As shown in FIG. 1, the gas sensing element 1 of this embodiment has the solid electrolytic substrate 11 which is configured into a plate shape and is made of an oxygen ion conductive zirconia. The measuring objective gas side electrode 121 and the reference electrode 122 are provided on opposed surfaces (upper and lower surfaces in the illustration of FIG. 1) of the solid electrolytic substrate 11. The solid electrolytic substrate 11, a spacer 14, and a substrate 15 are laminated in this order to define the chamber 140 therein. The measuring objective gas side electrode 121 is exposed to the chamber 140. The solid electrolytic substrate 11 and a spacer 13 are laminated to define a reference gas chamber 130 therein. The reference electrode 122 is exposed to the reference gas chamber 130.

A heater substrate 19 is laminated next to the spacer 13. A heat generating element 190 is embedded between the spacer 13 and the heater substrate 19. The heat generating element 190 generates heat in response to electric power supply to increase the temperature of the gas sensing element 1 to its activation level.

The gas introducing passage 150 is formed across the substrate 15. The diffusion resistive layer 16, made of a porous ceramic, is laminated on this substrate 15. The diffusion resistive layer 16 entirely covers outer surface of the substrate 15 including the outer opening portion 151 of the gas introducing passage 150 at the external environment side of the gas introducing passage 150. The outer surface of the diffusion resistive layer 16 is directly exposed to the external environment, with no additional member having substantial diffusion resistance on its outer surface 160.

Accordingly, when the exhaust gas serving as the measuring objective gas enters into the chamber 140 from the external environment, the diffusion rate of the exhaust gas is substantially determined by the diffusion resistive layer 16 and the gas introducing passage 150. The output of the gas sensing element 1 shows the limit current characteristics having a flat region appearing in the voltage-current characteristic curve where the current value is constant irrespective of increase of the voltage. The current value in the flat region is generally referred to as the limit current.

According to the embodiment shown in FIGS. 2A and 2B, the cross-sectional area “S” of the inner open end 152 of the gas introducing passage 150 is 0.1 mm². The circumferential length “L” of the inner open end 152 is 1.1 mm. The thickness “d” of the chamber 140 in the vicinity of the inner open end 152 is 0.09 mm, when taken along a line normal to the plane including the inner open end 152 of the gas introducing passage 150.

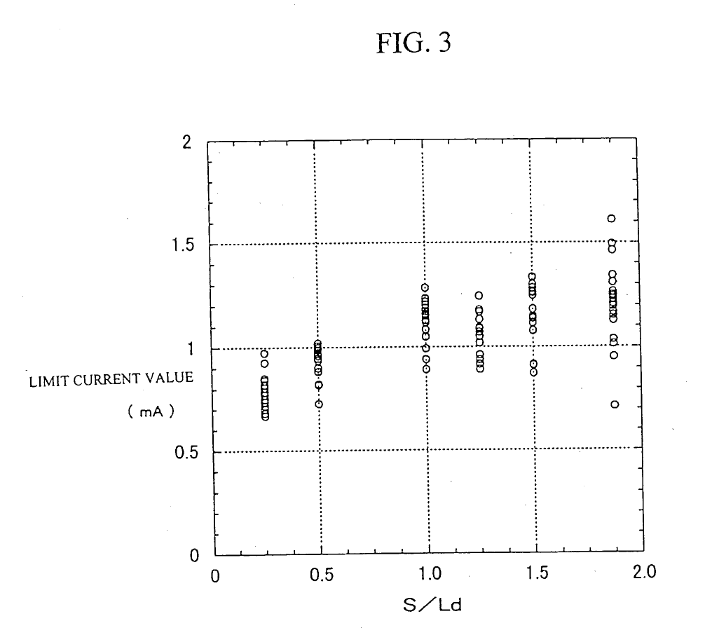

FIG. 3 is a graph showing limit current values measured in the atmospheric environment from many samples of the gas sensing element 1 of the first embodiment, which are mutually differentiated in the diameter of the gas introducing passage while the chamber thickness “d” is maintained at a constant value (d=0.09 mm).

As apparent from the map of FIG. 3, the manufacturing dispersion of the limit current values tends to become wide when S/Ld exceeds 1.5. In other words, the test data of FIG. 3 reveals that the high accurate measurement is unfeasible when S/Ld exceeds 1.5. The diffusion resistive layer can be cut or sliced to adjust or optimize the limit current so as to reduce the length of the diffusion path of the measuring objective gas. This makes it possible to provide a gas sensing element having a limit current value being easily adjustable.

Meanwhile, although not clearly shown in the drawing, there is the tendency that the limit current values converge to a particular value when S/Ld decreases below 0.25. Hence, no substantial change in the limit current value was recognized even when the diameter of the gas introducing passage is changed.

The functions and effects of the gas sensing element in accordance with the first embodiment will be explained hereinafter.

The gas sensing element 1 of the first embodiment has the gas introducing passage 150 connecting the chamber 140 and the external environment of the sensing element. The relationship S/Ld≦1.5 is established, when S represents the cross-sectional area of the inner open end 152 of the gas introducing passage 150 opening to the chamber 140, L represents the circumferential length of the inner open end 152 of the gas introducing passage 150, and d represents the thickness of the chamber 140 in the vicinity of the inner open end 152 of the gas introducing passage 150.

Satisfying the relationship S/Ld≦1.5 is effective to eliminate the influence of the inner open end 152 of the gas introducing passage 150 opening to the chamber 140 in determining the diffusion rate of the measuring objective gas entering into the chamber 140. Accordingly, the response of the gas sensing element 1 is substantially dependent on the distance of the gas introducing path or route extending from the outer surface of the diffusion resistive layer 16 to the inner open end 152 of the gas introducing passage 150 extending via the external environment side opening portion 151.

According to the arrangement of the gas sensing element 1, it is relatively easy to adjust the distance of the gas introducing path. For example, the length of the gas introducing passage 150 is adjustable by cutting the surface of a semi-finished plate member (i.e., substrate 15) across which the gas introducing passage 150 is formed. Alternatively, the length of the gas introducing path can be reduced by cutting the surface of the diffusion resistive layer 16.

Accordingly, satisfying the above relationship S/Ld≦1.5 makes it possible to provide a gas sensing element possessing excellent response.

Furthermore, cutting the diffusion resistive layer makes it possible to eliminate manufacturing dispersion in the sensor output. Hence, a gas sensing element possessing excellent measuring accuracy is obtained.

Providing the diffusion resistive layer 16 is effective to prevent the sensor output from varying depending upon the temperature of the measuring objective gas. The sensor output is accurately obtained. The diffusion resistive layer 16 is directly exposed to the external environment. No additional diffusion resistive member is provided on the outer surface 160 of the diffusion resistive layer 16. The diffusion path of the measuring objective gas introduced into the chamber 140 is substantially constituted by a single path. No superposition of sensor signals will appear in a transient response phase. The high accurate measurement can be assured.

### Second Embodiment

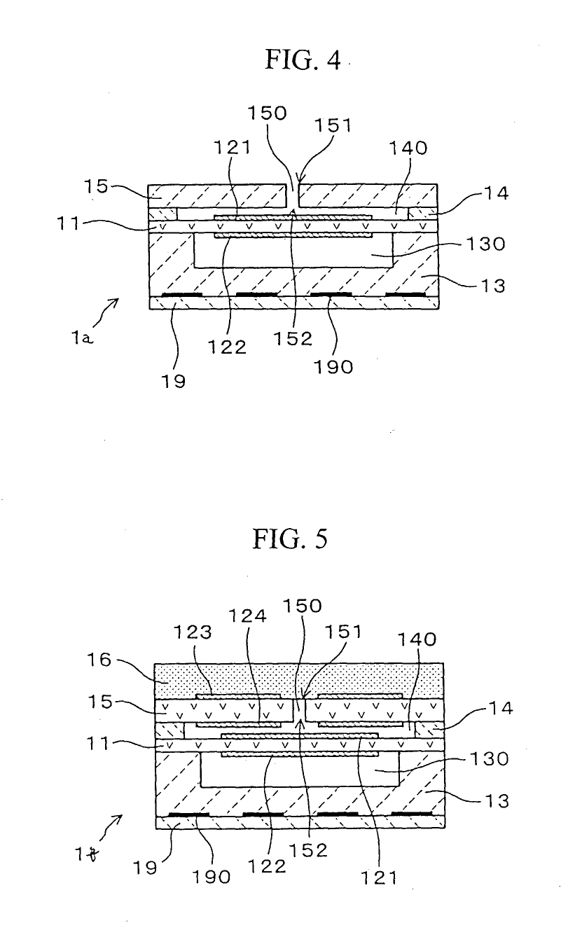

FIG. 4 shows a gas sensing element 1a in accordance with the second embodiment of the present invention, which is characterized in that no diffusion resistive layer is provided.

The gas sensing element 1a of the second embodiment includes the solid electrolytic substrate 11, the measuring objective gas side electrode 121 provided on one surface of the solid electrolytic substrate 11, and the reference electrode 122 provided on another surface of the solid electrolytic substrate 11. The measuring objective gas side electrode 121 is exposed to the chamber 140 defined in the laminated layers consisting of the solid electrolytic substrate 11, the spacer 14 and the substrate 15. The gas introducing passage 150 extends across the substrate 15 so as to connect the chamber 140 to the external environment of the gas sensing element 1a, so that the chamber 140 can directly communicate with the external environment. The gas measuring objective gas enters from the external environment to the chamber 140 via the gas introducing passage 150. The diffusion rate of the gas measuring objective gas is substantially determined by the gas introducing passage 150. The sensor output of the gas sensing element 1a shows the limit current characteristics.

The relationship S/Ld≦1.5 is established, when S represents the cross-sectional area of the inner open end 152 of the gas introducing passage 150 opening to the chamber 140, L represents the circumferential length of the inner open end 152 of the gas introducing passage 150, and d represents the thickness of the chamber 140 in the vicinity of the inner open end 152 of the gas introducing passage 150.

The rest of the arrangement of the second embodiment is substantially identical with that of the first embodiment. Hence, the second embodiment brings substantially the same functions and effects.

### Third Embodiment

FIG. 5 shows a gas sensing element 1b in accordance with the third embodiment of the present invention, which is a two-cell type gas sensing element.

The substrate 15 is constituted by a solid electrolytic member. A pair of electrodes 123 and 124 surrounding the gas introducing passage 150 is provided on opposed (i.e., upper and lower) surfaces of the substrate 15. The electrodes 123 and 124 and the solid electrolytic substrate 15 cooperatively constitute a pump cell for maintaining the oxygen concentration in the chamber 140 to a constant level.

The rest of the arrangement of the third embodiment is substantially identical with that of the first embodiment. Hence, the third embodiment brings substantially the same functions and effects.

### Fourth Embodiment

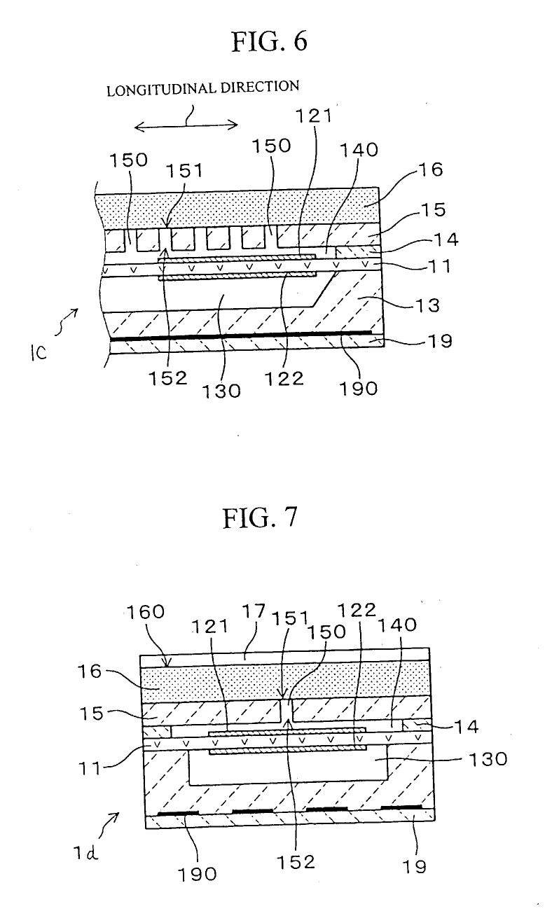

FIG. 6 shows a gas sensing element 1c in accordance with the fourth embodiment of the present invention, which is characterized by a plurality of gas introducing passages 150 formed across the substrate 15.

More specifically, a total of five gas introducing passages 150, each extending across the substrate 15, are aligned in the longitudinal direction of the gas sensing element 1c. The diffusion resistive layer 16, made of a porous ceramic, is laminated on the substrate 15. The diffusion resistive layer 16 entirely covers the outer surface of the substrate 15 including the outer opening portion 151 of each gas introducing passage 150 at the external environment side of the gas introducing passage 150. The outer surface of the diffusion resistive layer 16 is directly exposed to the external environment.

The rest of the arrangement of the fourth embodiment is substantially identical with that of the first embodiment.

The path for introducing the measuring objective gas into the chamber 140 is constituted by a combination of the gas introducing passage 150 and the diffusion resistive layer 16. When the area of the outer opening portion 151 of the gas introducing passage 150 opening to the external environment is constant, the diffusion resistance is determined irrespective of the number of gas introducing passages 150. Providing a plurality of gas introducing passages 150 brings the effect of separating the path of the measuring objective gas so that the measuring objective gas can be promptly introduced into the chamber 140. The response of the gas sensing element 1c is improved.

The fourth embodiment brings substantially the same functions and effects.

### Fifth Embodiment

FIG. 7 shows a gas sensing element 1d in accordance with the fifth embodiment of the present invention, which is similar to the gas sensing element 1 shown in FIG. 1 but is characterized by a trap layer 17 additionally provided on the outer surface 160 of the diffusion resistive layer 16.

More specifically, the trap layer 17 is a porous member made of numerous ceramic particles whose properties are thermally stable. In the trap layer 17, these ceramic particles are connected continuously. For example, various alumina and spinel members can be used as the ceramic particles for the trap layer 17.

Furthermore, the trap layer 17 has the porosity of approximately 15%. In other words, the diffusion resistance of the trap layer 17 is negligible. Accordingly, the gas sensing element 1d of this embodiment includes the diffusion resistive layer 16 with no additional diffusion resistive member provided on its outer surface 160. The trap layer 17 having no substantial diffusion resistance is provided on the outer surface 160 of the diffusion resistive layer 16. The trap layer 17 traps the poisonous components contained in the measuring objective gas, thereby preventing the diffusion resistive layer 16 and the measuring objective gas side electrode 121 from deteriorating.

The rest of the arrangement and functions and effects of the fifth embodiment are substantially identical with those of the first embodiment.

### Sixth Embodiment

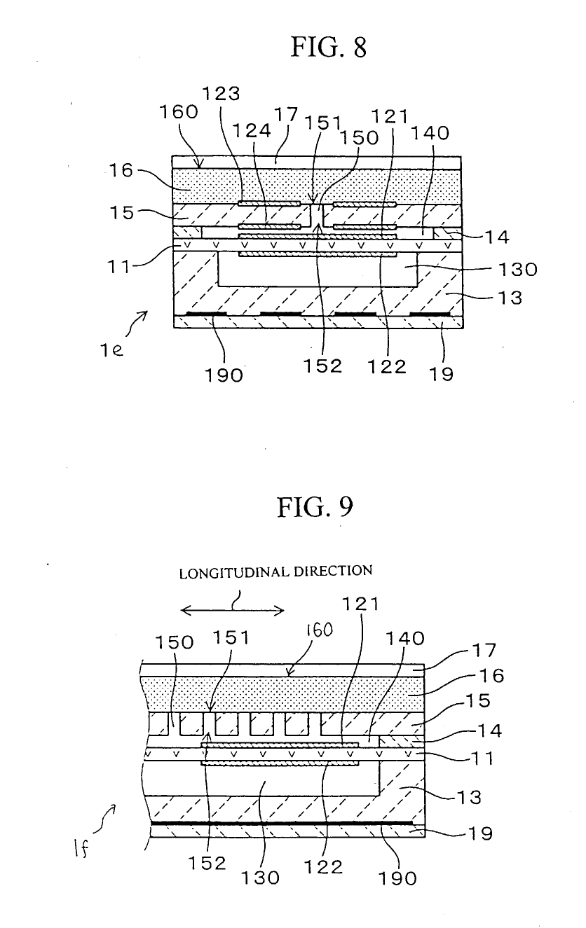

FIG. 8 shows a gas sensing element 1e in accordance with the sixth embodiment of the present invention, which is similar to the gas sensing element 1b shown in FIG. 5 but is characterized by the trap layer 17 additionally provided on the outer surface 160 of the diffusion resistive layer 16.

More specifically, the gas sensing element 1e in accordance with the sixth embodiment is a two-cell type gas sensing element including a sensor cell for measuring the concentration of a specific gas contained in the measuring objective gas of the chamber 140 as well as an oxygen pump cell for charging and discharging oxygen into and from the chamber 140.

The sensor cell consists of the solid electrolytic substrate 11, the measuring objective gas side electrode 121 provided on the solid electrolytic substrate 11, and the reference electrode 122 exposed to the reference gas chamber 130 into which the air is introduced. The sensor cell is provided at the position corresponding to the inner open end 152 where the gas introducing passage 150 faces the chamber 140.

Furthermore, the substrate 15 for forming the gas introducing passage 150 is an electrolytic substrate. The above-described oxygen pump cell consists of the solid electrolytic substrate 15, the paired pump electrodes 123 and 124 provided on this substrate 15 so as to surround the gas introducing passage 150. The pump electrode 124 is exposed to the chamber 140. The oxygen pump cell maintains the oxygen concentration in the chamber 140 to a constant value.

Furthermore, the diffusion resistive layer 16 is laminated on the solid electrolytic substrate 15. The trap layer 17 is provided on the outer surface 160 of the diffusion resistive layer 16. Accordingly, the gas sensing element 1e of this embodiment includes the diffusion resistive layer 16 with no additional diffusion resistive member provided on its outer surface 160. The trap layer 17 having no substantial diffusion resistance is provided on the outer surface 160 of the diffusion resistive layer 16. The trap layer 17 traps the poisonous components contained in the measuring objective gas, thereby preventing the diffusion resistive layer 16 and the measuring objective gas side electrode 121 from deteriorating.

The rest of the arrangement and functions and effects of the sixth embodiment are substantially identical with those of the first, third, or fourth embodiment.

### Seventh Embodiment

FIG. 9 shows a gas sensing element 1f in accordance with the seventh embodiment of the present invention, which is characterized by the trap layer covering a plurality of gas introducing passages 150 formed across the substrate 15.

More specifically, a total of five gas introducing passages 150, each extending across the substrate 15, are aligned in the longitudinal direction of the gas sensing element 1f. The diffusion resistive layer 16, made of a porous ceramic, is laminated on the substrate 15. The diffusion resistive layer 16 entirely covers the outer surface of the substrate 15 including the outer opening portion 151 of each gas introducing passage 150 at the external environment side of the gas introducing passage 150. The trap layer 17 is provided on the outer surface 160 of the diffusion resistive layer 16.

The rest of the arrangement of the seventh embodiment is substantially identical with that of the first embodiment.

Accordingly, the gas sensing element 1f of this embodiment includes the diffusion resistive layer 16 with no additional diffusion resistive member provided on its outer surface. 160. The trap layer 17 having no substantial diffusion resistance is provided on the outer surface 160 of the diffusion resistive layer 16. The trap layer 17 traps the poisonous components contained in the measuring objective gas, thereby preventing the diffusion resistive layer 16 and the measuring objective gas side electrode 121 from deteriorating.

The rest of the arrangement and functions and effects of the seventh embodiment are substantially identical with those of the first, fourth, or sixth embodiment.

### Comparative Example

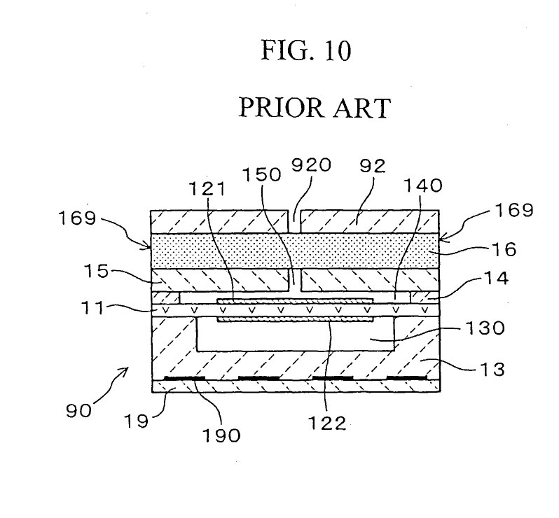

FIG. 10 shows a comparative gas sensing element 90 having the arrangement similar to that of the first embodiment shown in FIG. 1 but different in that an additional substrate 92 is laminated on the diffusion resistive layer 16 with a pinhole 920 extending across this substrate 92 (For example, refer to Japanese Utility Model Publication No. 7-23735). The pinhole 920 has a diffusion resistance having an influence in determining the diffusion rate of the measuring objective gas entering into the chamber 140.

According to this comparative gas sensing element 90, the measuring objective gas is introduced from the pinhole 920 and also from both side surfaces 169 of the diffusion resistive layer 16. In other words, three different kinds of gas introducing paths are provided. This arrangement is inferior to the above-described preferred embodiments of the present invention in that superposition of at least two types of sensor signals will appear in a transient response phase. Thus, the measuring accuracy and the response of the sensing element 90 are unsatisfactory.

While the invention has been shown and described in detail, the foregoing description is in all aspects illustrative and not restrictive. It is therefore understood that numerous other modifications and variations can be devised without departing from the scope of the invention.

What is claimed is:

1. A gas sensing element comprising a solid electrolytic substrate, a measuring objective gas side electrode provided on a surface of said solid electrolytic substrate, and a reference electrode provided on another surface of said solid electrolytic substrate, wherein
said measuring objective gas side electrode is exposed to a chamber;
a gas introducing passage is provided for connecting said chamber to an external environment of said gas sensing element; and
a relationship S/Ld≦1.5 is established
where S represents a cross-sectional area of an inner open end of said gas introducing passage opening to said chamber, L represents a circumferential length of said inner open end of said gas introducing passage, and d represents a thickness of said chamber in the vicinity of said inner open end of said gas introducing passage.

2. The gas sensing element in accordance with claim 1, wherein said S, L and d further satisfy a relationship 0.25≦S/Ld≦1.25.

3. The gas sensing element in accordance with claim 1, wherein at least one another introducing passage is provided in addition to said gas introducing passage.

4. The gas sensing element in accordance with claim 1, wherein said gas sensing element is a two-cell type.

5. The gas sensing element in accordance with claim 1, wherein said gas sensing element is a two-cell type element having a sensor cell for measuring the concentration of a specific gas contained in said measuring objective gas introduced in said chamber and an oxygen pump cell for charging or discharging oxygen into or from said chamber,
said sensor cell comprises a solid electrolytic substrate, a measuring objective gas side electrode provided on said solid electrolytic substrate, and a reference electrode exposed to a reference gas chamber into which the air is introduced, and said sensor cell is positioned so as to face the inner open end of said gas introducing passage where said gas introducing passage opens into said chamber, and
said pump cell comprises a solid electrolytic substrate and a pair of pump electrodes provided on said solid electrolytic substrate, and one of said pump electrodes is positioned so as to be exposed to said chamber.

6. The gas sensing element in accordance with claim 1, wherein said gas introducing passage has an outer opening portion opening to the external environment, and a trap layer for trapping poisonous components contained in said measuring objective gas is provided so as to cover said outer opening portion of said gas introducing passage.

7. A gas sensing element comprising a solid electrolytic substrate, a measuring objective gas side electrode provided on a surface of said solid electrolytic substrate, and a reference electrode provided on another surface of said solid electrolytic substrate, wherein
said measuring objective gas side electrode is exposed to a chamber;
a gas introducing passage is provided for connecting said chamber to an external environment of said gas sensing element;
a diffusion resistive layer, which is made of a porous member, covers an outer opening portion of said gas introducing passage at an external environment side of said gas introducing passage, with no additional diffusion resistive member provided on an outer surface of said diffusion resistive layer; and
a relationship S/Ld≦1.5 is established
where S represents a cross-sectional area of an inner open end of said gas introducing passage opening to said chamber, L represents a circumferential length of said inner open end of said gas introducing passage, and d represents a thickness of said chamber in the vicinity of said inner open end of said gas introducing passage.

8. The gas sensing element in accordance with claim 7, wherein said S, L and d further satisfy a relationship 0.25≦S/Ld≦1.25.

9. The gas sensing element in accordance with claim 7, wherein at least one another introducing passage is provided in addition to said gas introducing passage.

10. The gas sensing element in accordance with claim 7, wherein said gas sensing element is a two-cell type.

11. The gas sensing element in accordance with claim 7, wherein said gas sensing element is a two-cell type element having a sensor cell for measuring the concentration of a specific gas contained in said measuring objective gas introduced in said chamber and an oxygen pump cell for charging or discharging oxygen into or from said chamber,
said sensor cell comprises a solid electrolytic substrate, a measuring objective gas side electrode provided on said solid electrolytic substrate, and a reference electrode exposed to a reference gas chamber into which the air is introduced, and said sensor cell is positioned so as to face the inner open end of said gas introducing passage where said gas introducing passage opens into said chamber, and
said pump cell comprises a solid electrolytic substrate and a pair of pump electrodes provided on said solid electrolytic substrate, and one of said pump electrodes is positioned so as to be exposed to said chamber.

12. The gas sensing element in accordance with claim 7, wherein a trap layer for trapping poisonous components contained in said measuring objective gas is provided on an outer surface of said diffusion resistive layer.
